(19) United States
(12) Patent Application Publication
(10) Pub. No.: US 2005/0177861 A1
(43) Pub. Date: Aug. 11, 2005

(54) Asynchronous integration of portable handheld device

(75) Inventors: Yue Ma, West Windsor, NJ (US); Chieh-Chung Chang, Monmouth Jct., NJ (US); Rajesh Bhagwandas Khandelwal, Bridgewater, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD, Osaka (JP)

(21) Appl. No.: 10/509,655

(22) PCT Filed: Mar. 31, 2003
(86) PCT No.: PCT/US03/09882

Related U.S. Application Data
(60) Provisional application No. 60/370,446, filed on Apr. 5, 2002.

(51) Int. Cl. H04N 7/16; H04N 7/18; G06F 13/00; H04N 5/445; G06F 3/00

(52) U.S. Cl. 725/135; 725/40; 725/80; 725/39; 725/43

(57) ABSTRACT

A system is provided for seamless synchronization through asynchronous integration of Internet content with broadcast content within a portable handheld device (14), such as a remote control or a personal digital assistant (PDA). The handheld device (14) receives program-related data from the television (12) while the user is watching a program. The program-related data places the handheld device (14) in sync with the program the user is watching and augments the user's enjoyment of the program by providing supplemental broadcast information or additional interactive features. The handheld device (14) is also configured to retrieve additional supplemental information from at least one content source distinct from the broadcast source.

### FIELD OF THE INVENTION

The present invention relates generally to interactive television, and more particularly, to a system for seamlessly synchronizing Internet content with broadcast content within a portable handheld device.

### BACKGROUND OF THE INVENTION

There is considerable interest today in ways to integrate supplemental content information with broadcast media. For example, broadcasters seek ways to engage viewers by providing interactive content from a disparate content source, such as the Internet, that coincides with or supplements the program being broadcast. However, current interaction with the Internet is quite limited today, because the typical TV viewer does not have a personal computer conveniently located in the TV viewing room, nor is the typical TV viewer able to navigate to the appropriate Internet addresses while watching the TV program. In addition, current interaction approaches try to synchronize the supplemental Internet content with the broadcast program content by controlling the timing of the respective information sources. This approach has a number of problems, among them being that synchronization cannot occur if the broadcast content is delayed as through recording or timeshifting.

The present invention addresses these concerns by seamlessly synchronizing the supplemental Internet content with the broadcast content within a portable handheld device, such as a remote control or a personal digital assistance (PDA). The handheld device receives program-related data from the television while the user is watching a program. The program-related data places the handheld device in sync with the program the user is watching and augments the user's enjoyment of the program by providing supplemental broadcast information or additional interactive features. The handheld device is also configured to retrieve additional supplemental broadcast information from at least one content source distinct from the broadcast source.

For a more complete understanding of the invention, its objects and advantages refer to the following specification and to the accompanying drawings.

### BRIEF DESCRIPTION OF THE DRAWINGS

FIG. 1 is a diagram depicting an exemplary interactive TV system in accordance with the present invention;

FIG. 2 illustrates exemplary advertisement information which may be displayed to the viewer of a broadcast commercial via the handheld device in accordance with the present invention;

FIG. 3 is diagram illustrating how additional supplemental broadcast data is retrieved from a disparate content source in accordance with the present invention;

FIG. 4 illustrates an exemplary electronic coupon which may be downloaded to the handheld device of the present invention; and

FIG. 5 is a block diagram of an exemplary architecture used to implement the interactive TV system of the present invention.

### DETAILED DESCRIPTION OF THE PREFERRED EMBODIMENTS

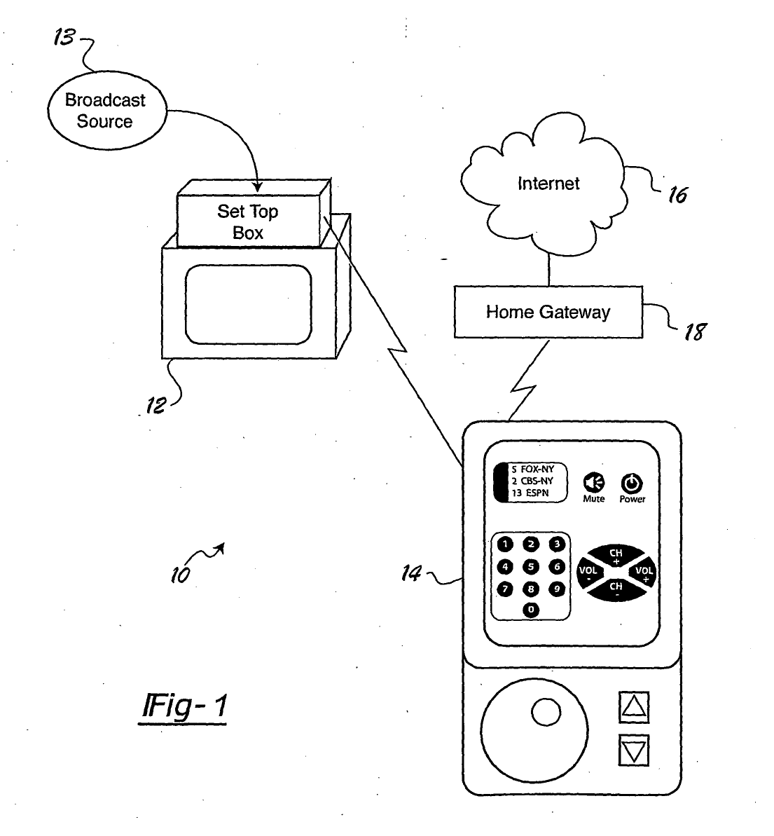

FIG. 1 illustrates an exemplary interactive TV system 10 that achieves synchronization through asynchronous integration of information from disparate sources. The interactive TV system 10 is generally comprised of a television 12, a portable handheld device 14, and at least one disparate media content source 16, such as the Internet. The television 12 is configured to receive audio/visual content from a broadcast source 13 and deliver the audio/visual content to a viewer as is well known in the art. The audio/visual content received from the broadcast source 13 may also be encoded with supplemental broadcast data, including but not limited to electronic program guide data, closed caption data, program-related data, etc. It is readily understood that at least some of the supplemental broadcast data may be delivered to the viewer via the television 12.

To enhance the viewing experience, at least some of the supplemental broadcast data may be transmitted via a wireless communication link to the handheld device 14. In accordance with the present invention, the television 12 (or accompanying set-top box) may be operable to transmit supplemental broadcast data that correlates to the broadcast program currently being viewed. The supplemental broadcast data may then serve as the basis for providing interactive features to the viewer.

For example, advertisement information corresponding to a broadcast commercial may be displayed to the viewer by the handheld device 14 as shown in FIG. 2. In this example, the viewer is watching a broadcast commercial from Pizza Pal while watching an ongoing television program corresponding to a basketball game (as shown in the subtitle under the “Live” menu). Additional product description information and a related word game may simultaneously appear on the user interface of the handheld device 14. It is envisioned that other related advertisement information, such as product name, product manufacture, local retail locations including address and phone number, web site address, etc., may also be provided to the viewer via the handheld device 14.

In another example, information related to the broadcast program the user is watching may appear on the handheld device 14. Program-related information may include anecdotal information about the program, biographical information for the program's actors, program producer's commentary, questions from a quiz show, statistics associated with a broadcasted sporting event, etc. It is readily understood that other types of interactive features may be implemented on the handheld device 14.

To further enhance the viewers interactive experience, the handheld device 14 is configured to retrieve additional supplemental broadcast data from a disparate content source 16 as shown in FIG. 3. To do so, the supplemental broadcast data 32 received from the broadcast source 13 is embedded with trigger data. Upon receipt of the supplemental broadcast data 32, the handheld device 14 is operable to parse out any trigger data embedded therein and store it in a data store residing in the handheld device 14. The trigger data is then used to retrieve additional supplemental information from the disparate content source 16.

A request for additional information 34 is formulated by the handheld device 14. The request 34 is transmitted via a wireless communication link to the disparate content source 16. In response to the request, additional supplemental information 36 is sent from the disparate content source 16 to the handheld device 14. It is important to note that the request may be sent asynchronously from the receipt of the supplemental broadcast data from the broadcast source and that the additional supplemental information may be sent asynchronously from the request for the information. The additional supplemental information is then used by the handheld device 14 to further enhance the viewers interactive experience.

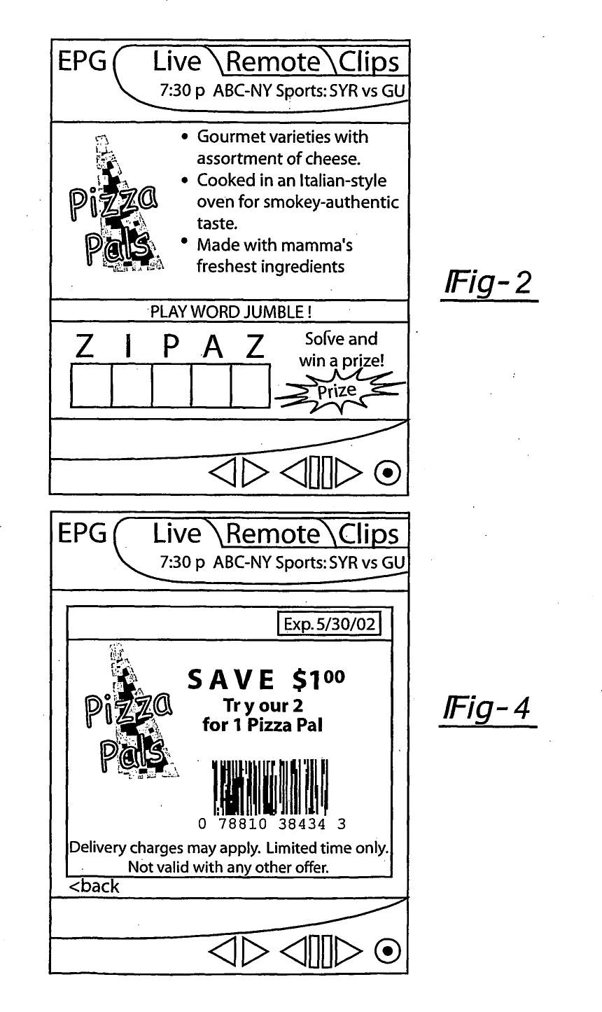

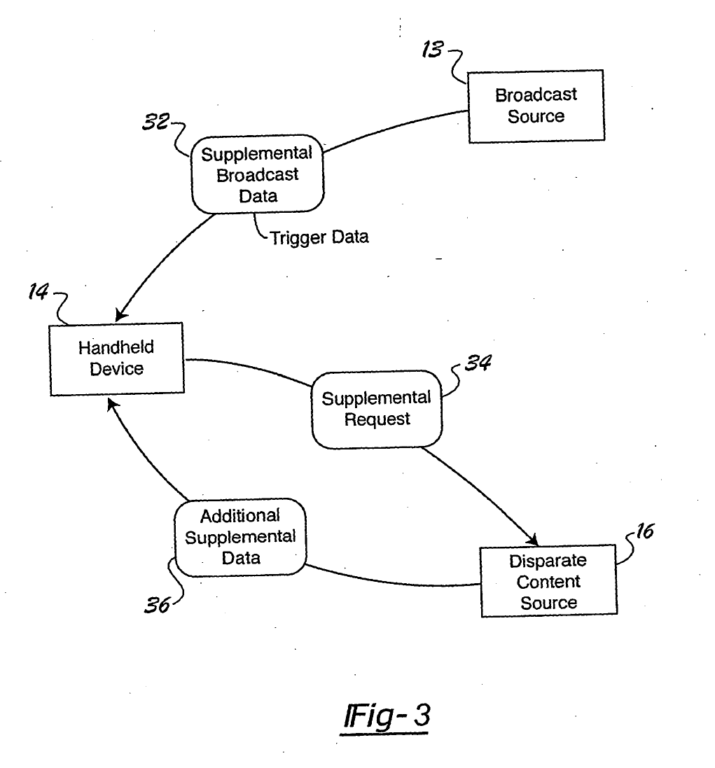

An enhanced interactive experience is further described below. During a broadcast television commercial, an electronic coupon corresponding to the advertised goods or services may be available to the viewer. Supplemental broadcast data transmitted to the handheld device may initiate a display that alerts the viewer as to the availability of the coupon. In one instance, the viewer then requests retrieval of the coupon using the handheld device 14. Alternatively, the availability of the coupon to the viewer may be based on a game related to the commercial, such as the word game shown in FIG. 2. In this instance, successful completion of the game by the viewer prompts retrieval of the coupon. In either instance, the electronic coupon is subsequently downloaded to the handheld device 14 from a disparate content source 16 as described above. An exemplary coupon is shown in FIG. 4. It is envisioned that the electronic coupon may be redeemable at either an on-line shopping venue or a local retail establishment.

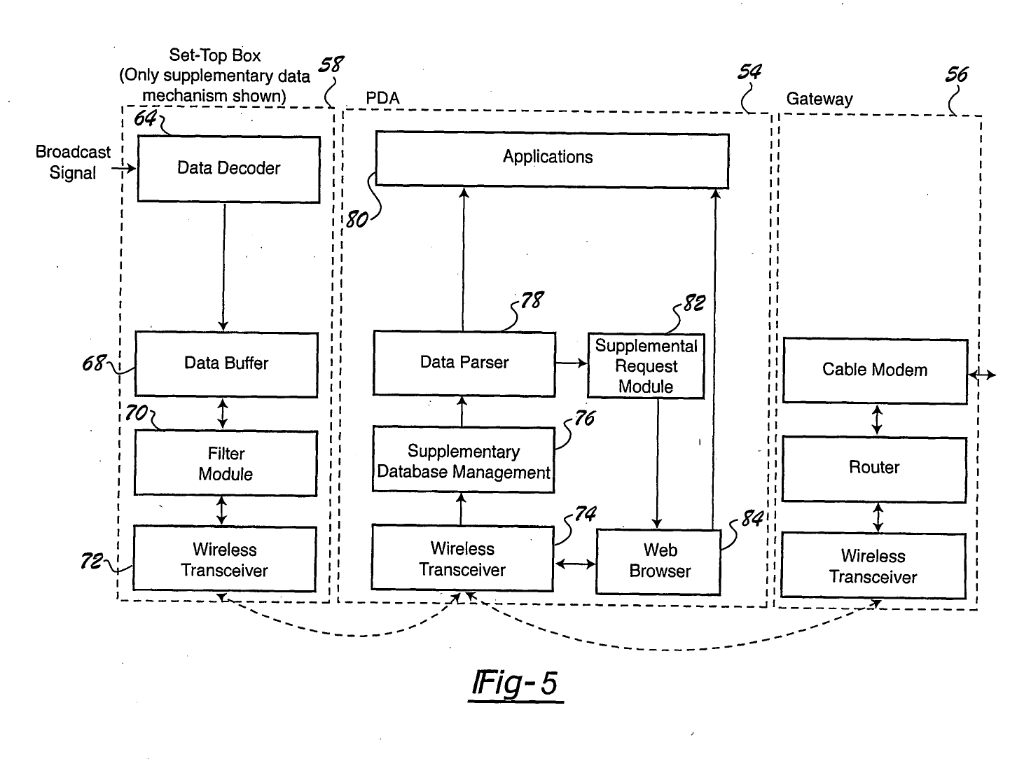

An exemplary system architecture for implementing the present invention is described in relation to FIG. 5. The primary components of the system architecture 50 may include a television 52, a personal digital attendant (PDA) 54, and a home gateway 56. While the following description is provided with reference to a PDA, it is readily understood that the broader aspects of the present invention are applicable to remote control devices, cellular phones and other portable handheld devices.

In a conventional analog domain, the vertical blanking interval (VBI) is the portion of the television signal that is used to carry supplemental broadcast data. In digital broadcasting, supplemental broadcast data can be transmitted within the digital transport stream. The system architecture 50 may further include a set-top box 58 for decoding supplementary data from the TV signal (only supplementary data mechanism is drawn). Although a set-top box is presently preferred, it is readily understood that the decoding function may be incorporated into the TV or into another add-on device (e.g., DVD recorder) which may be used in conjunction with the television. It is also understood that other data encoding techniques are also within the scope of the present invention.

The set-top box 58 is adapted to receive the incoming TV signal from the broadcast source. In order to retrieve supplementary data, the set-top box 58 includes a data decoder 64. The data decoder 64 is a hardware component that pulls supplementary data off of the incoming TV signal. In analog broadcast domain, the data decoder 64 can be a VBI decoder. In digital domain, the data decoder 64 can be a section filter implemented within a transport stream decoder. The data decoder 64 may be configured to read a specified channel and decode the data transmitted in the specified channel.

Since supplementary data is transmitted at only certain time intervals on each channel, it is not instantaneously available upon request from the TV signal. Rather, the system is designed to buffer supplementary data as it becomes available. The data decoder 64 can be configured to constantly retrieve all available data from the TV signal and stores it in a data store 68 residing on the set-top box.

The set-top box 58 further includes a filter module 70 and a wireless transceiver device 72. The filter module 70 is a software module that retrieves supplementary data from the data buffer 68 that correlates to the ongoing activities on the handheld that involve supplementary information from the broadcast source. For example, when an interactive game is transmitted to the handheld in association with a TV commercial, upon the user playing the game, the electronic coupon, which is stored in data buffer 68, is downloaded to the handheld. The user may also pre-configure the data filter module 70 to send supplementary information only in certain categories. For advertisement, however, the user may not be able to block all commercials, but can pre-select a minimum number of favorite categories of commercials such as tools, gardens, and/or health products.

The supplementary broadcast data is then transmitted via the wireless transceiver device 72 to the PDA 14. The data is preferably transmitted by the wireless transceiver device 72 using the Bluetooth protocol, IEEE 802.11b protocol or some other known wireless communication protocol. The same principle can equivalently be applied in both analog and digital TV broadcasting, in which the data encoding and decoding are different.

The PDA 54 serves as the focal point for the viewer's interactive television experience. To enhance the viewing experience, at least one application 80 residing on the PDA 14 is configured to continuously stream supplementary broadcast data which correlates to the audio/visual content being viewed on the television. Applications are preferably developed using Java or some other known application development tool.

In one embodiment, supplementary data is received at the PDA 14 using a wireless transceiver device 74 and then stored in a supplementary database 76. To ease interaction with other applications residing on the PDA, supplementary data is preferably stored in XML format. A data parser 78 serves to retrieve the supplementary data from the supplementary database 76 and translate it into a format useable by the application 80. Various commercially available XML-based parsers may be used to implement the data parser.

In order to retrieve additional supplemental data from the Internet, the data parser 78 detects any trigger data which may be embedded in the supplementary broadcast data. Upon detection, the data parser 78 parses out the trigger data and passes it to a supplemental request module 82. The supplemental request module 82 then formulates the request for any additional supplemental information.

In one embodiment, the additional supplemental information is retrieved from the Internet via a home gateway 56. In particular, the supplemental information is retrieved by a web browser 84 using retrieval techniques well known in the art. The supplemental information may be passed in real-time by the web browser 84 to the application 80, where it is displayed to the viewer. Alternatively, the supplemental information may be stored in a data store residing on the PDA for subsequent presentation to the viewer. In either case, the supplemental information may be embedded with data that may be used to synchronize the presentation of the supplemental information with the audio/visual content being viewed on the television.

The home gateway 18 may include a wireless transceiver 92, a router 94, and a cable modem 96 as is well known in the art. However, it is readily understood that other means (e.g., a cellular or satellite communication link) may be employed to access the Internet. Alternatively, the additional supplemental information may be retrieved from a local content source (e.g., SD or CF memory cards) and/or other remote content sources.

One skilled in the art will readily recognize that some or all of the functionality embedded in the PDA may be performed in one or more other devices associated with the broadcast environment, including but not limited to a digital video recorder, the television, the settop box, the home gateway or other known devices. Likewise, it is readily understood that at least some of the functionality embedded in the settop box or the television may be integrated into the PDA.

The description of the invention is merely exemplary in nature and, thus, variations that do not depart from the gist of the invention are intended to be within the scope of the invention. Such variations are not to be regarded as a departure from the spirit and scope of the invention.

1. A method for asynchronously accessing supplementary media content based on broadcast media content received from a broadcast signal for use with a handheld device, comprising:
receiving trigger information extracted from the broadcast media content;
obtaining supplementary media content from a disparate source of media content; and
accessing the supplementary media content based on the trigger information, wherein said accessing occurs asyncronously, without simultaneous connection to a source of the broadcast signal and the disparate source of media content during said accessing.

2. The method of claim 1, comprising receiving broadcast media content having trigger information embedded therein.

3. The method of claim 1, comprising extracting the trigger information from the broadcast media content.

4. The method of claim 1, comprising delivering broadcast media content received from the broadcast signal.

5. The method of claim 1, comprising communicating trigger information extracted from the broadcast signal to the handheld device.

6. The method of claim 1, comprising delivering the supplementary media content to a consumer of the broadcast media content.

7. The method of claim 6, comprising employing a communication capability of the hand-held device to deliver the supplementary media content to the consumer of the broadcast media content.

8. The method of claim 1, comprising obtaining the supplementary media content associated with broadcast media content prior to delivery of the broadcast media content to a consumer.

9. The method of claim 1, comprising storing the supplementary media content in a memory of the handheld device.

10. The method of claim 1, comprising obtaining the supplementary media content from a disparate source of media content based on the trigger information.

11. The method of claim 10, wherein the disparate source corresponds to at least one of the Internet, an external data source, and a mobile network.

12. The method of claim 1, wherein said receiving trigger information includes receiving an identification tag adapted to identify the broadcast media content.

13. The method of claim 1, wherein said receiving trigger information includes receiving an identification tag adapted to identify the supplementary media content.

14. The method of claim 1, wherein said obtaining supplementary media content includes obtaining an identification tag.

15. The method of claim 1, wherein said obtaining supplementary media content includes obtaining descriptive text.

16. The method of claim 1, wherein said obtaining supplementary media content includes obtaining binary information.

17. The method of claim 16, wherein said obtaining binary information includes obtaining an image file.

18. The method of claim 16, wherein said obtaining binary information includes obtaining a media file.

19. The method of claim 16, wherein said obtaining binary information includes obtaining software operable to execute an interactive game.

20. The method of claim 1, wherein said obtaining supplementary media content includes obtaining hyper text markup language.

21. The method of claim 1, wherein said wherein said obtaining supplementary media content includes obtaining a link to a location of supplementary media content on a communications network.

22. The method of claim 1, wherein said obtaining supplementary media content includes obtaining compressed information.

23. The method of claim 1, wherein said obtaining supplementary media content includes obtaining uncompressed information.

24. The method of claim 1, comprising retrieving supplementary media content stored in memory of the handheld device based on ongoing activities of the handheld device relating to the supplementary media content.

25. The method of claim 1, comprising retrieving supplementary media content stored in memory of the handheld device based on user-defined categories relating to desired supplementary, media content.

26. A supplementary media content access system employing a handheld device, comprising:
an input of the handheld device receiving trigger information extracted from the broadcast media content;
a supplemental request module obtaining supplementary media content from a disparate source of media content; and
a parser accessing the supplementary media content based on the trigger information.

27. The system of claim 26, comprising a set top box receiving broadcast media content having trigger information embedded therein.

28. The system of claim 26, comprising a decoder extracting the trigger information from the broadcast media content.

29. The system of claim 26, comprising a media delivery device delivering broadcast media content received from the broadcast signal.

30. The system of claim 26, comprising a set top box communicating trigger information extracted from the broadcast signal to the handheld device.

31. The system of claim 26, comprising a media delivery device delivering the supplementary media content to a consumer of the broadcast media content.

32. The system of claim 31, comprising a graphic user interface of the handheld device delivering the supplementary media content to the consumer of the broadcast media content.

33. The system of claim 26, wherein said supplemental request module is adapted to obtain the supplementary media content associated with broadcast media content prior to delivery of the broadcast media content to a consumer.

34. The system of claim 26, comprising a memory of the handheld device storing the supplementary media content.

35. The system of claim 26, wherein said supplemental request module is adapted to obtain the supplementary media content from a disparate source of media content based on the trigger information.

36. The method of claim 35, wherein the disparate source corresponds to at least one of the Internet, an external data source, and a mobile network.

37. The system of claim 26, wherein said input receives an identification tag adapted to identify the broadcast media content.

38. The system of claim 26, wherein said input receives an identification tag adapted to identify the supplementary media content.

39. The system of claim 26, wherein said supplemental request module obtains an identification tag.

40. The system of claim 26, wherein said supplemental request module obtains descriptive text.

41. The system of claim 26, wherein said supplemental request module obtains binary information.

42. The system of claim 41, wherein said supplemental request module obtains an image file.

43. The system of claim 41, wherein said supplemental request module obtains a media file.

44. The system of claim 41, wherein said supplemental request module obtains software operable to execute an interactive game.

45. The system of claim 26, wherein said supplemental request module obtains hyper text markup language.

46. The system of claim 26, wherein said wherein said supplemental request module obtains a link to a location of supplementary media content on a communications network.

47. The system of claim 26, wherein said supplemental request module obtains compressed information.

48. The system of claim 26, wherein said supplemental request module obtains uncompressed information.

49. The system of claim 26, comprising a filter module retrieving supplementary media content stored in memory of the handheld device based on ongoing activities of the handheld device relating to the supplementary media content.

50. The system of claim 26, comprising a filter module retrieving supplementary media content stored in memory of the handheld device based on user-defined categories relating to desired supplementary media content.

51. A method of asynchronously providing information to a portable device from a broadcast source and an information source, comprising:
supplying first information to said portable device from said broadcast source;
requesting second information from said information source based on said first information; and
supplying said second information to said portable device.

52. A method of asynchronously using information in a portable device, comprising:
using said portable device to receive first information from a broadcast source;
using said portable device to provide control instructions to a second system based on said first information;
using said second system to perform an operation based on said control instructions.

53. A method of asynchronously using information from a broadcast source, comprising:
using a tuner to selectively input first information from a broadcast source into a portable device;
using said portable device to provide control instructions to a second system based on said first information;
using said second system to perform an operation based on said control instructions.
media content in a supplementary database:
parsing and translating said stored supplementary media content into a format; and
accessing the supplementary media content based on the trigger information, wherein said accessing occurs asynchronously, without simultaneous connection to a source of the broadcast signal and the disparate source of media content during said accessing.
